(19) United States
(12) Patent Application Publication
(10) Pub. No.: US 2021/0349465 A1
(43) Pub. Date: Nov. 11, 2021

(54) AUTONOMOUS SCOOTER

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 16/293,631

(22) Filed: Mar. 5, 2019

Related U.S. Application Data
(63) Continuation-in-part of application No. 15/451,405, filed on Mar. 6, 2017, now Pat. No. 10,245,937.

(51) Int. Cl. G05D 1/02; B62K 3/00; B62K 11/14; B62K 21/22; B62M 7/12; B62J 99/00; B60W 10/08; B60W 10/20; B60W 10/26

(52) U.S. Cl. CPC G05D 1/0223; B60W 2300/365; G05D 1/0257; G05D 1/0278; G05D 1/0289; B62K 3/002; B62K 11/14; B62K 21/22; B62M 7/12; B62J 99/00; B60W 10/08; B60W 10/20; B60W 10/26; B62K 2202/00; B62K 2207/02; B62J 2099/0013; B62K 2204/00; B60W 2420/22; B60W 2420/42; B60W 2420/52; B60W 2510/081; B60W 2510/083; B60W 2520/18; B60W 2530/10; B60W 2520/105; B60W 2520/125; B60W 2550/10; B60W 2720/24; G05D 1/0246

(57) ABSTRACT

Respectively a rider of the autonomous scooter may select a manual drive mode to drive without any assistance, or the rider may control the autonomous scooter remotely by a smartphone when riding or not aboard via a smartphone APP whereby the rider may engage a user interface system providing virtual driving control settings linked with an autonomous drive system to control the autonomous scooter, or the rider can manually control the autonomous scooter. Primarily elements of the autonomous scooter may comprise a platform defined by a front end and a rear end, a deck section to place the rider's feet thereon, and having a base supporting a steering column. Accordingly the steering column is rotatably connected by a motorized wheel adapter configured to turn a suspension fork arrangement containing at least one motorized wheel thus steering and balance control of the autonomous scooter, or the steering column is connected to a truck arrangement containing two motorized wheels, whereby the two motorized wheels provide balance and differential propulsion for steering the autonomous scooter. The motorized wheel adapter and the motorized wheels are systematically controlled by an autonomous drive system adapted to control the autonomous scooter during autonomous drive mode setting.

### CROSS REFERENCED TO RELATED APPLICATIONS

A notice of issuance for a continuation in part patent application in reference to application Ser. No. 15/451,405; filing date: Mar. 6, 2017; titled: Vehicle Comprising Autonomous Steering Column System.

### BACKGROUND

### 1. Field of the Invention

Embodiments of the present invention are in the technical field of electric scooters. Further specific embodiments of the present invention relate to autonomous and manual controlled electric scooter types.

### 2. Description of Related Art

Conventional electric scooters are configured for a rider to stand or sit during operation the rider manually controls steering and velocity by a steering column with handles including throttle and typically uses either a thumb lever cabled to a brake unit or uses a foot brake fin to slow or stop the rear wheel. Nowadays autonomous controlled vehicle technology is utilized for small electrics vehicles therefore it would be apparent to autonomize scooters to operate autonomously for commercial or personal use.

As an example, the Gillett patent application Ser. No. 15/451,405; filing date: Mar. 6, 2017, titled: “Vehicle Comprising Autonomous Steering Column System” discloses a small electric vehicle utilizing object detecting sensors, a control panel and a motorized steering actuator situated on a steering column, however the rider semi-autonomously controls the steering and speed, what is needed is an autonomous scooter that is capable of autonomously driving to various destinations while remaining upright with or without a rider present.

### SUMMARY

The present autonomous scooter offers framework comprising specified information based on semiautonomous and autonomous control to operate independently without input of user instruction based on an autonomous drive system having control logic, more specifically the control logic having programming for correlating with a user interface which allows a rider to select various control mode which may include an autonomous drive mode, a semiautonomous drive mode and a gravity motion control mode, and the control logic having programming for correlating with mechanical functions to navigate the autonomous scooter through indoor or outdoor environments with or without a rider being onboard. More specifically, the autonomous drive mode is selected by the rider is riding the autonomous scooter, or by a user who is not present. Respectively, the rider is riding the autonomous scooter may remotely control the autonomous scooter from wireless devices. Respectively, the autonomous scooter user who is not present, remotely controls the autonomous scooter from wireless devices or a remote network. More specifically, the autonomous scooter operates independently without input from a remote user via an external wireless device, a phone APP, or by a remote network linked to the autonomous scooter's autonomous drive system.

In various elements, the autonomous drive system is schematically linked with semiautonomous drive mode and schematically linked with the rider's manual drive processes, more specifically, the semiautonomous drive mode is correspondingly associated for detecting the riders-induced motions via a sensor system sensing an orientation of the rider's footing placement and stance. Respectively, autonomous drive system processes and the gravity motion control mode are configured to detect the presence of the rider during manual drive processes. Respectively the autonomous scooter framework comprises two kinds of wheel arrangements, either wheel arrangement systematically operates in a manner to provide a controlled turn to keep the autonomous scooter upright during running operations, or either wheel arrangement systematically operates in a manner to provide controlled steering to drive the autonomous scooter in various directions in an operating environment. Respectively the autonomous scooter's gravity motion control mode and the semiautonomous drive mode are associating with the rider performing manual maneuvers by a steering column comprising mechanical components configured for controlling propulsion, steering and balance maneuvers of the autonomous scooter. More specifically, the present application offers an autonomous scooter framework which offers steering column components utilizing two kinds of wheel arrangements, the wheel arrangements are configured to operate in a manner to keep the autonomous scooter upright during running operations. Respectively the autonomous scooter's first wheel arrangement comprising a front suspension fork and on a rear suspension fork, accordingly the front suspension supports one or more wheels containing a motor mounted therein, wherein the motorized wheel adapter being coupled at an intersection of the steering column and the front suspension fork, wherein the motorized wheel adapter configured to actuate a turn angle of the front suspension fork such that the one or more wheels steer in lateral directions thus keeping the autonomous scooter balance and upright, whereas the second wheel arrangement including a truck comprising two wheels each having a motor mounted therein, respectively the two wheels configured to engage a differential drive angle to thus turn a steering direction of the autonomous scooter.

In various elements, the autonomous drive system is associated with one or more motor controllers which are configured to cause the motors to propel the autonomous scooter in various directions based on which control mode is engaged or disengaged by the rider. Accordingly, during a manual drive mode the autonomous scooter's propulsion can be controlled by the rider leaning forward or backward or by the rider using a throttle, and during autonomous drive mode an autonomous drive system controls the steering, velocity, balance, and placement of the autonomous scooter, the rider's footing orientation and pressure information which is measured by the load sensor and the autonomous drive system instructs the one or more wheels, via motor propulsion, to move, to turn differentially or turn left/right thereby autonomously driving the autonomous scooter during semi-autonomous drive mode.

In various elements, the autonomous scooter comprises a control panel for the rider to monitor or select a menu and gauges for adjusting the moving speed, checking a battery level, and for accessing GPS local mapping, or examining other useful information, and may utilize a phone providing user interface, wherein the phone connections via WIFI, Bluetooth, Internet, and network associated with the rider and the user interface, and a phone provided with an APP, wherein the APP having software configured for monitoring and/or controlling the navigation of the autonomous scooter. Accordingly the phone provided with an APP, the APP for monitoring and/or controlling navigation or the autonomous scooter initiated by user instructions or by network instructions, respectively the user interface system associating with WIFI, Bluetooth, Internet, or associating with a graphical user interface, a network interface system for initiating instructions by a remote.

In various elements, the autonomous drive system is associated with a sensor system for detection a rider's orientation and for controlling motorized operations to propel, steer and balance the autonomous scooter, and control logic for correlating with a user interface allowing a rider to select control modes which may include an autonomous drive mode, a semi-autonomous drive mode, a manual drive mode, and a gravity motion control mode. Respectively the gravity motion control mode configured to detect, via sensor system, a rider-induced motion or position of the rider such as the rider leans forward the rider's pose increases motor speed or as the rider leans back the rider's pose slows motor speed whereby triggering the autonomous drive system to control a motor speed by controlling battery power directed to the motors, another pose function may include the rider leaning right to left assisting balance and steering control by leaning laterally side to side.

Accordingly during the autonomous drive mode, respectively the autonomous drive system controls the steering, velocity, balance by a sensor system providing an array of sensors which may include; a load sensor, an accelerometer sensor, a gyroscope sensor, a deformation sensor, an inertial measurement unit (IMU), LIDAR sensor, Radar, and cameras which are coupled to the platform and steering column, which accordingly provide output signals with data to the autonomous drive system, and the autonomous drive system provides control logic for controlling the movement of the one or more wheels, and control the placement of the one or more wheel to assist balance control.

### BRIEF DESCRIPTION OF THE DRAWINGS

FIG. 1A, FIG. 1B, FIG. 1C, and FIG. 1D illustrate an autonomous scooter 100A and 100B in accordance with one or more embodiments of the present invention.

FIG. 1E and FIG. 1F illustrate a steering column utilizing motorized wheel components configured for steering and balancing an autonomous scooter 100 in accordance with one or more embodiments of the present invention.

FIG. 2A and FIG. 2C illustrate see through views of the platform sections and a compartment arrangement housing various system components in accordance with one or more embodiments of the present invention.

FIG. 3A and FIG. 3B illustrate a flowchart representing an autonomous's Sensor System 300 in accordance with one or more embodiments of the present invention.

FIG. 4 illustrates a diagram representing an autonomous scooter's Autonomous Drive System 400 in accordance with one or more embodiments of the present invention.

FIG. 5 illustrates a diagram representing an autonomous scooter's Motion Assistant Gravity Control System 500 in accordance with one or more embodiments of the present invention.

FIG. 6 schematically illustrates a flowchart representing an autonomous scooter's Autonomous Drive Mode 600 in accordance with one or more embodiments of the present invention.

FIG. 7 schematically illustrates a diagram representing an autonomous scooter's Manual Drive Mode 700 disclosing processes and data storage in accordance with embodiments of the present invention.

FIG. 8 schematically illustrates a flowchart representing an autonomous scooter's User Interface System 800 in accordance with one or more embodiments of the present invention.

FIG. 9 schematically illustrates a diagram representing an autonomous scooter's phone APP 900 in accordance with one or more embodiments of the present invention.

### DETAILED DESCRIPTION OF THE DRAWINGS

The accompanying drawings serve to illustrate the embodiments and principles disclosed and described embodiments. However, these drawings are being presented for illustrative purpose only, it is to be understood that not intended to limit the restriction of the relevant invention, as disclosed in the embodiments the autonomous scooter can be semi-autonomously controlled with input from a rider via a user interface system or the autonomous scooter can be controlled autonomously with minimal interaction from the rider.

In various embodiments the autonomous scooter framework may utilize a platform configured for supporting footing placement and/or may utilized a seat. Accordingly, the autonomous scooter without a seat is identified as the autonomous vehicle 100A, accordingly the autonomous scooter 100B is configured with a seat for a rider 101 to sit on. More specifically the autonomous scooter may be referred to herein as the “autonomous scooter 100”. Respectively the autonomous scooter is utilized when a rider needs small electric vehicle transportation to get from one location to another location. Primarily elements of the autonomous scooter comprise a platform defined by a front end and a rear end, a deck section to place the rider's feet thereon, a base, a steering column, a suspension fork, at least one wheel or a truck with two wheels; and a compartment, wherein the steering column is connected on a suspension fork and rotatably coupled to the base, wherein the compartment is disposed at the base and accessibly fastened thereon, wherein the suspension fork supports at least one wheel comprising a motor mounted therein, wherein the motor configured to propel the autonomous scooter, wherein the truck comprising two wheels each having a motor mounted therein, wherein the two wheels configured to differentially turn the autonomous scooter in various steering directions, wherein a motorized wheel adapter is configured for mounting the truck on a bottom portion of the steering column, wherein the steering column is coupled on a front section of the base, a battery, a charger and a control module are mounted within the compartment, wherein wiring is electrically connecting battery power to electronic components; an autonomous drive system adapted to control driving and direction of the autonomous scooter during autonomous drive mode setting, these and other embodiments are described herein.

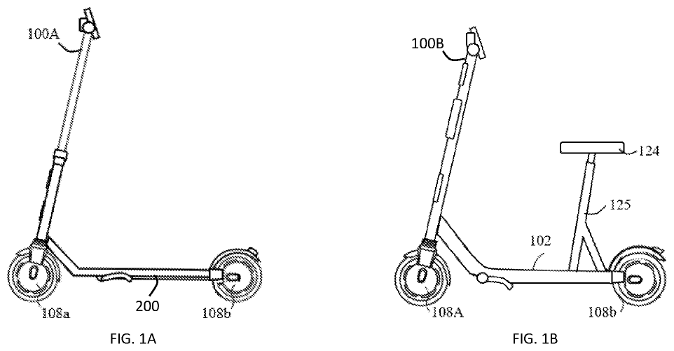

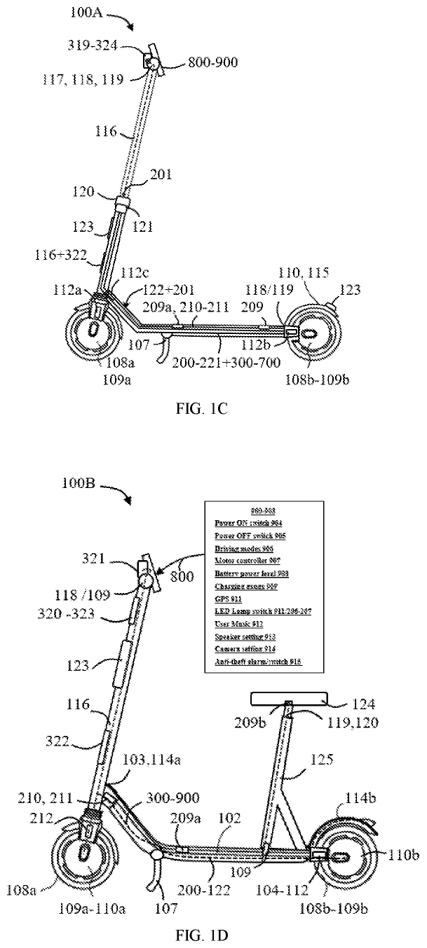

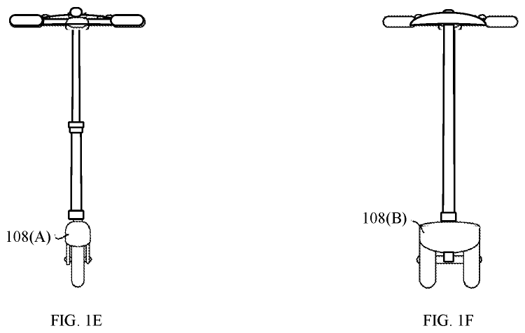

In greater detail FIG. 1A and FIG. 1C exemplify an autonomous scooter 100A propelled forwardly perceivably as a rider 101 steps onboard a platform configured with load sensors, with skill, to balance the scooter the rider 101 physically controls the motion, position and motor speed of the autonomous scooter, accordingly, the rider by using leg stance and footing placement to skillfully lean forwardly and sideways controls velocity of the autonomous scooter 100A.

In greater detail FIG. 1B and FIG. 1D exemplify an autonomous scooter 100B configured with similar elements of the autonomous scooter 100A however, the autonomous scooter 100B is configured having a seat 124 supported by conduit frame or seat post 125, wherein the seat 124 may be configured with a load sensor or a deformation sensor 112, perceivably as a rider 101 steps onboard the footing placement as well as sits on the seat 123. Accordingly, the rider may control velocity of the autonomous scooter 100B via deformation sensor modes 500 which is detailed further in FIG. 5. As exemplified, in FIG. 1B the autonomous scooter 100B is configured as an example representing; a bicycle, an ATV, a motorcycle, or other electric scooter like vehicles.

In greater detail an autonomous scooter 100A (without a seat) exemplified in FIG. 1A and an autonomous scooter 100B (with a seat) exemplified in FIG. 1B comprise; a platform 102 defined by a front end 103 and a rear end 104, a deck section 105 and a base section 106, a kickstand 107, accordingly the platform may utilize a wheel 108 (e. g., one or more wheels depending on which wheel arrangement) for propulsion, or may use a dummy wheel, accordingly a front wheel 108a or a front dummy wheel can be steered by a steering column 116. Accordingly the base defined by a front end and a rear end, a deck to place the rider's feet thereon, a steering column configured with handles; a wheel arrangement which may include; a first wheel arrangement comprising a suspension fork configured for supporting one or more wheels containing a motor mounted therein, a motorized wheel adapter being coupled at an intersection of the steering column and the front suspension fork, respectively the motorized wheel adapter configured to actuate a turn angle of the suspension fork such that the one or more wheels steer in lateral directions to keep the autonomous scooter balanced and upright; or a second wheel arrangement comprising a truck containing two wheels each having a motor mounted therein, respectively the two wheels configured to engage a differential drive angle to thus turn a steering direction of the autonomous scooter; or a third wheel arrangement comprising a suspension fork configured for supporting at least one dummy not comprising a motor. The steering column 116 is configured a control panel having a display for the rider to access user interface system components 800-900 or the steering column is utilized by the rider to manually control the travel direction of the autonomous scooter. Wherein, the steering column 116, the platform 102 and a compartment 200 contain system components 201-221 and array of sensor object tracking devices 319-324, 300-700, 800/900 providing numerous control methodologies and system elements disclosed herein.

The wheel 108 wherein comprising; an electric motor 109, a brake unit 110, a suspension fork 111, a deformation sensor 112, an axle, and a wheel adapter comprising bearings and bolting means, not shown, for coupling the electric motor 109 on the suspension fork, the suspension fork having an upper cantilevered assembly configured for coupling on a base section of the platform 102.

In one non-limiting embodiment, the electric motor 109 e. g., referred to also as “motor” may utilize a gearbox or a belt drive motor arrangement, or supports a rear electric motor 109b comprising a gear shifter with cable gear 114 connecting at a rear end 104 of the platform 102, as well, the brake unit 110 may be that of; a disc brake or a hydraulic brake configured having braking levers with cable gear 114 connecting to the disc brake or hydraulic brake.

In various elements the wheel further comprises a suspension fork 111 and a deformation sensor 112 configured within the suspension fork 111, the deformation sensor wherein comprises a strain gauge 112a configured to sense induced strain by imbalanced forces exerted upon autonomous scooter 100. The deformation sensor 112 to sense strain level 112b induced by a rider's weight exerted on the wheel 108 during running maneuvers. The deformation sensor 112 to sense strain level 112c induced by a rotation speed and twisting angle differences at a connection point generated at an intersection of the steering column 116, the wheel 108a and the platform's front end 103, and the deformation sensor 112 to sense strain level induced by a rotation speed and twisting angle differences at a connection point generated at an intersection of the wheel 108b and the platform's rear end 104.

In various elements, the front suspension fork 111a connects the wheel 108a to a bottom portion of the steering column 116, and a rear suspension fork 111b connects the wheel 108b to the rear end 104 the wheel 108b may be manually slowed or stopped by a brake fin 115.

In various elements the wheel 108 further comprises a suspension fork 111 and a deformation sensor 112 configured within the suspension fork 111, wherein the deformation sensor comprises a strain gauge 112a configured to sense induced strain by imbalanced forces exerted upon autonomous scooter 100A/100B. The deformation sensor 112 to sense strain level 112b induced by a rider's weight exerted on the wheel 108 and during running maneuvers. The deformation sensor 112 to sense strain level induced by a rotation speed and twisting angle differences at a connection point generated at an intersection of the steering column 116, the wheel 108a and the platform's front end 103. The deformation sensor 112 to sense strain level induced by a rotation speed and twisting angle differences at a connection point generated at an intersection of the wheel 108b and the platform's rear end 104.

In various elements, the front suspension fork 111a connects the wheel 108a to a base bottom portion of the steering column, and a rear suspension fork 1121b connects the wheel 108b to the platform's rear end 104 the rear wheel 108b is slowed or stopped by a brake fin 115.

(Newly amended) In various elements, the rider via the steering column 116 controls the steering of front wheel 108a.

The right handle 117a supports a thumb throttle 118 and the left handle 117b supports a thumb brake 119 in the form of levers. The handles operatively connected to the wheels 108a, 108b so as to accelerate or decelerate the angular velocity of the wheels 108 and thereby the speed of the motor 109. For example, manipulating the accelerator thumb throttle 118 increases angular velocity of the wheels 108a, 108b, and manipulating the thumb brake 119 or brake lever which decreases angular velocity of said wheels 108a, 108b. The right thumb throttle 118 and the left thumb brake 119 are defined by different colors to help visually discern the accelerator from the brake. This can be useful when operating at high speeds or with distractions. Further, the right handle 117a and the left handle 117b form grips that allow the rider to more effectively manually steer. The accelerator and brake are either manually engaged by the rider or the accelerator and brake are automatically engaged by an autonomous drive system 400.

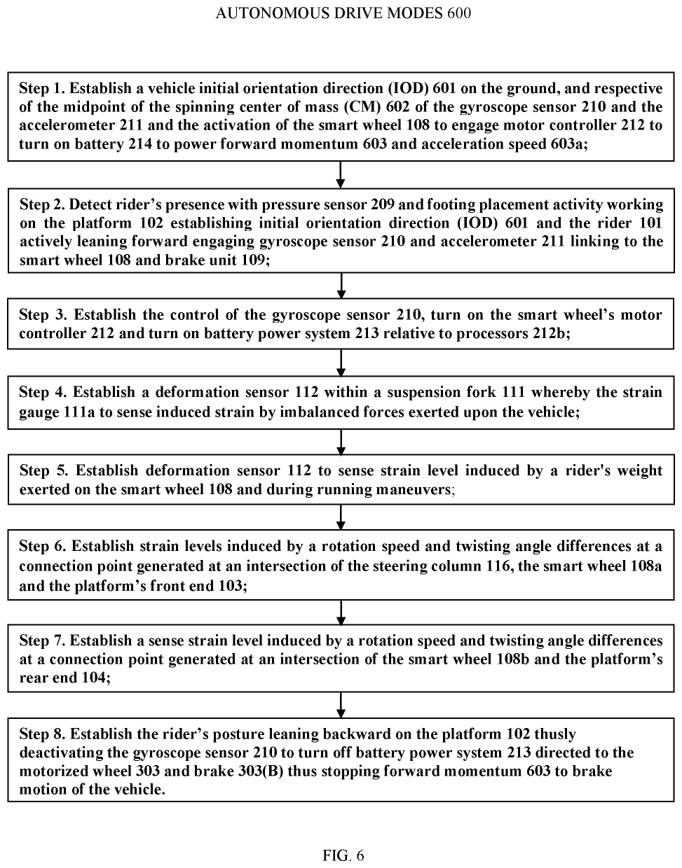

The steering column 116 containing system external motor controllers e.g., throttle/brake levers 118-119 electrically linking via an array of electrical wiring and connections 120 to autonomous drive system 400, see FIG. 6A, FIG. 6B components housed within a compartment 200, and wirelessly linked to a user interface system 800 providing user control through phone settings via a mobile app 900 with user settings, see listings.

The platform 102 of said autonomous scooter 100B supports the steering column 116 extending perpendicularly from the front end 103. The rider 101 can turn the steering column 116 in the desired direction during manual operation mode. In one non-limiting embodiment, the steering column 116 is about 45″ long. Though in other operating embodiments, the steering column can be shorter, longer, via an adapter pin 120 or collapsible via a hinge 121.

Accordingly a truck is configured having two motorized wheels 108a, 108b situated in parallel on the truck, accordingly the truck is connecting on a front section of the platform, respectively each wheel 108a, 108b are rotatable configured to propel the autonomous scooter. The motorized wheels 108a, 108b comprise an electric motor 109 which provides differential drive to turn said autonomous scooter 100 in various directions.

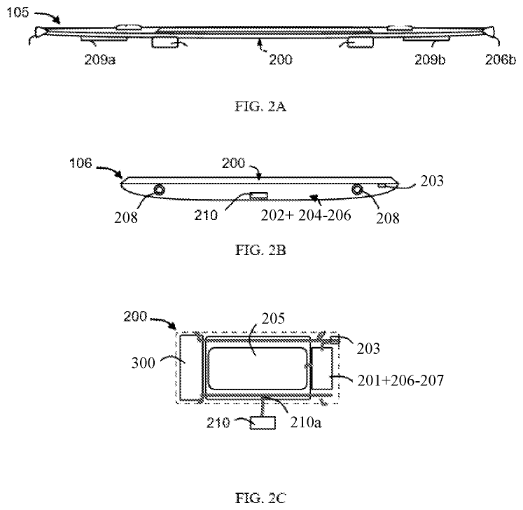

The platform 102 further comprises an array of integrated sensors including; load sensors 209a, 209b, and a gyroscopic sensor 210 and an accelerometer 211, respectively the load sensor 209 or “orientation sensor” configured to measure an orientation of the rider's presence when stepping on the deck section 105. The wheels 108a, 108b further comprises an array of sensors so as to accelerate or decelerate the angular velocity of the wheels 108a, 108b, the sensor arrangements are detailed in FIG. 2-FIG. 5.

The platform 102 and steering column 115 assemblies further comprising; a LED cord 122 that leads along the length of the base section and leading up to the steering column 115, and the steering column's LED head and turn signal lamps 123 provide light for visibility for other road users as well, a sensor system providing an array of sensors including object detection and avoidance sensors which may include; a short-range LIDAR sensor 321, a video camera 323 and a long-distance high-radar sensor 322 are situated on sections of the steering column 115 and the platform 102.

In greater detail FIG. 1E illustrates a steering column configured with handles, and a wheel arrangement disposed on a bottom portion of the steering column, respectively the wheel arrangement may include a first wheel arrangement 108(A) or a second wheel arrangement (B) controlled by an autonomous drive system, wherein the first wheel arrangement comprising a front suspension fork and on a rear suspension fork, accordingly the front suspension supports one or more wheels containing a motor mounted therein, wherein the motorized wheel adapter being coupled at an intersection of the steering column and the front suspension fork, wherein the motorized wheel adapter configured to actuate a turn angle of the front suspension fork such that the one or more wheels steer in lateral directions to keep the autonomous scooter balance and upright.

In greater detail FIG. 1F illustrates the second wheel arrangement including a truck configured to keep the autonomous scooter balance and upright when idle or when running comprises two wheels each having a motor mounted therein, respectively the two wheels configured to engage a differential drive angle to thus turn a steering direction of the autonomous scooter.

In greater detail FIG. 2A illustrates the platform 102 comprising internal sensors including load sensors 209, a gyroscopic sensor 210 and an accelerometer 211, the load sensor 209 or “orientation sensor” configured to measure an orientation of the rider's presence on a platform section. The gyroscopic sensor 210 and accelerometer 211 are adapted to maintain fore-and-aft balancing of the platform 102, and accordingly the preferred battery power level is activated via a motor controller 212 which is electronically linked to an array of Bluetooth devices 202 via a wiring array 201 and a USB charger port 203 situated on the platform 102, respectively the rider 101 can plug in personal devices to charge via the USB charger port 203.

As illustrated FIG. 2B and FIG. 2C illustrates the platform's deck section 105 and the base section 106, wherein the compartment 200 is contained within a platform base section 106, wherein the compartment 200 contains an electrical wiring array 201 linking to an array of internal and external Bluetooth devices 202, the Bluetooth devices 202 attached to platform sections. Accordingly, wherein the compartment 200 contains an electrical wiring array 201 linking to a battery 204 comprising a power control module 205, and a battery charger 206. The electrical wiring array 201 linking the battery power directly to built-in Bluetooth devices 202 which may include audio speakers 204 and LED lighting elements 208. Accordingly, the deck section 205 is electrically connected to an internal deformation sensor 111 and load sensors 209, as well as motor sensors, e. g., 109, not shown. Accordingly, the internal load sensors 209, 210, and 211 are contained between the deck and base sections 105/106, respectively the gyroscopic sensor 210 (with fuzzy logic 210a) and an accelerometer 211, the load sensor providing data based on gyroscope sensor data 210a and base on accelerometer sensor data 211a, and motor controller 212 server 212a and processor 212b, and motor controller sensor data 212c.

The rechargeable battery 204 stores electricity for powering one or more electric motors 109 and powering an array of autonomous drive system 300 associating with various electrical USB charge port to charge external components. The rechargeable battery 204 must be recharged from time to time from an external power source.

The compartment contains one or more removable battery packs 204 charged by a battery charger 206, the control module 205 providing sensor data 205a, the battery charger 206 providing a charging level 207 and sensor data 205a, said battery charger 206 is electrically linked to an external AC outlet power source.

The compartment 200 further contains lighting elements; LED lamps 208a, 208a which are electrically coupled via wiring array 201, the gyroscopic sensor 210, an accelerometer 211, and a motor controller 212 (i.e., linking to user interface system prompt settings via APP 900). Respectively the gyroscope sensor 210 providing an intelligent weight and motion controlling means, and an accelerometer 211 configured to measure balance which is achieved as soon as the rider steps on the upper deck section 201, subsequently when rider dismounts or is not detected on the deck by load sensors 209a, 209b, and accordingly the preferred power level is activated via the motor controller 212.

In various elements the battery's power control module further comprises a receiver 205b and a processor 205c for monitoring a charge level 207 of one or more removable battery packs 204 during a charging process. Wherein the battery charger 206 via the wiring array 201 connects the battery packs in a series. The battery packs 204 when fully charged can be switched out and used later to extend riding time.

The Sensor System 300 comprising an array of sensors connecting with one or more processors 315 and memory 316, and sensor data 317 being configured to determine a location of the autonomous scooter 100 in the environment 318, a localizer system 319 may receive sensor data 317 from a sensor system 317. In some examples, sensor data 317 received by localizer system 319 may not be identical to the sensor data 317 received by the output signals 320. For example, output signals 320 may receive and/or transmit sensor data 317 from one or more sensors including but not limited to; LIDAR 321 (e.g., 2D, 3D, color LIDAR), RADAR 322, and video cameras 323 (e.g., image capture devices); whereas, localizer system 319 may receive sensor data 317 including but not limited to global positioning system (GPS) 324 having data including; inertial measurement unit (IMU) data 325, map data 326, route data 327, Route Network Definition File (RNDF) data 328 and odometry data 329, wheel encoder data 330, and map tile data 331. Localizer system 319, having a planner system 332 having memory 333 and may receive object data 334 from sources other than sensor system 316, such as utilizing memory 333 via a data store, data repository, etc.

Accordingly perception system 320 may process sensor data 317 to generate object data 334 that may be received by the planner system 332. Object data 334 may include but is not limited to data representing object classification 335, detecting an object type 336, object track 337, object location 338, predicted object path 339, predicted object trajectory 340, and object velocity 341, in an operating environment 318.

Accordingly the localizer system 319 may process sensor data 317, and optionally, other data, to generate position and orientation data 342, local pose data 344 that may be received by the planner system 332. The local pose data 344 may include, but is not limited to, data representing a location of the autonomous scooter 100 in the operating environment 318 via (GPS) 324, (IMU) data 325, map data 326, route data 327, (RNDF) data 328 and odometry data 329, wheel encoder data 330, and map tile data 331, for example.

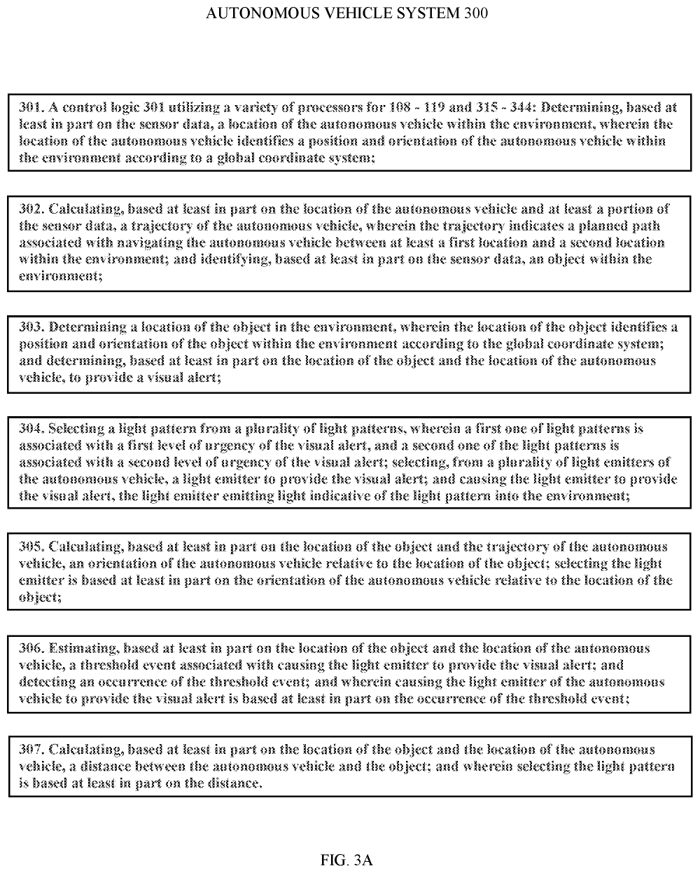

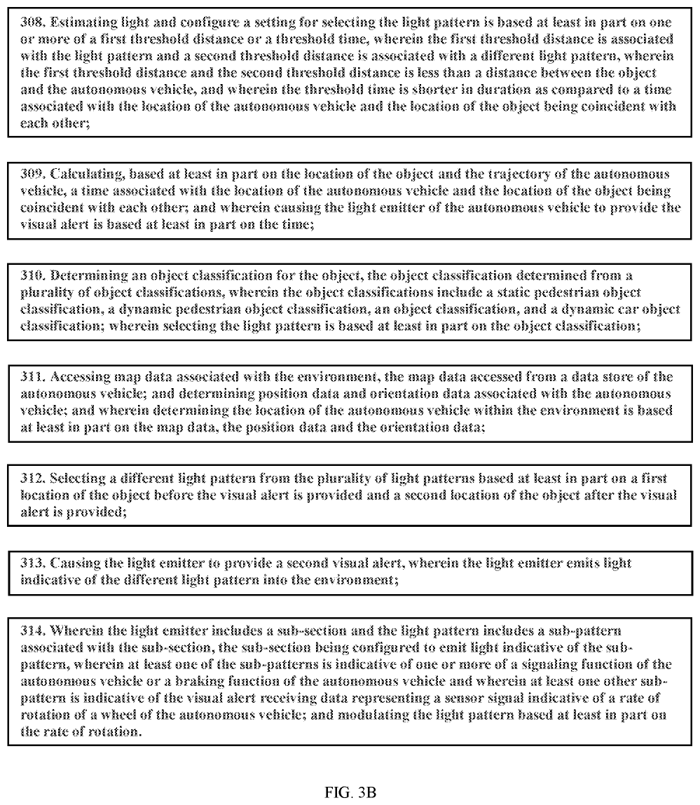

In greater detail FIG. 3A and FIG. 3B illustrates a flowchart for a sensor system 300 comprising methodologies identifies as 301-345 configured to detect objects in environment, to determine an object track for objects, classify objects, track locations of objects in environment, and detect specific types of objects in environment, such as traffic signs/lights, road markings, lane markings and the like, the system including: 301. A sensor system of the autonomous scooter 100 comprising processors for: Determining, based at least in part on the sensor data, a location of the autonomous scooter 100 within an operating environment, wherein the location of the autonomous scooter 100 identifies a position and orientation of the autonomous scooter within the environment according to a global coordinate system; 302. Calculating, based at least in part on the location of the autonomous scooter 100 and at least a portion of the sensor data, a trajectory of the autonomous scooter 100, wherein the trajectory indicates a planned path associated with navigating the autonomous scooter 100 between at least a first location and a second location within the environment; and identifying, based at least in part on the sensor data, an object within the environment; 303. Determining a location of the object in the environment, wherein the location of the object identifies a position and orientation of the object within the environment according to the global coordinate system; and determining, based at least in part on the location of the object and the location of the autonomous scooter 100, to provide a visual alert; 304. Selecting a light pattern from a plurality of light patterns, wherein a first one of light patterns is associated with a first level of urgency of the visual alert, and a second one of the light patterns is associated with a second level of urgency of the visual alert; selecting, from a plurality of light emitters of the autonomous scooter 100 a light emitter to provide the visual alert; and causing the light emitter to provide the visual alert, the light emitter emitting light indicative of the light pattern into the environment; 305. Calculating, based at least in part on the location of the object and the trajectory of the autonomous scooter 100, an orientation of the autonomous scooter 100 relative to the location of the object; selecting the light emitter is based at least in part on the orientation of the autonomous scooter 100 relative to the location of the object; 306. Estimating, based at least in part on the location of the object and the location of the autonomous scooter 100, a threshold event associated with causing the light emitter to provide the visual alert; and detecting an occurrence of the threshold event; and wherein causing the light emitter of the autonomous scooter 100 to provide the visual alert is based at least in part on the occurrence of the threshold event; 307. Calculating, based at least in part on the location of the object and the location of the autonomous scooter 100, a distance between the autonomous scooter 100 and the object; and wherein selecting the light pattern is based at least in part on the distance.

Continued, 308. Estimating light and configure a setting for selecting the light pattern is based at least in part on one or more of a first threshold distance or a threshold time, wherein the first threshold distance is associated with the light pattern and a second threshold distance is associated with a different light pattern, wherein the first threshold distance and the second threshold distance is less than a distance between the object and the autonomous scooter 100, and wherein the threshold time is shorter in duration as compared to a time associated with the location of the autonomous scooter 100 and the location of the object being coincident with each other; 309. Calculating, based at least in part on the location of the object and the trajectory of the autonomous scooter 100, a time associated with the location of the autonomous scooter 100 and the location of the object being coincident with each other; and wherein causing the light emitter of the autonomous scooter 100 to provide the visual alert is based at least in part on the time; 310. Determining an object classification for the object, the object classification determined from a plurality of object classifications, wherein the object classifications include a static pedestrian object classification, a dynamic pedestrian object classification, an object classification, and a dynamic car object classification; wherein selecting the light pattern is based at least in part on the object classification; 311. Accessing map data associated with the environment, the map data accessed from a data store of the autonomous scooter 100; and determining position data and orientation data associated with the autonomous scooter 100; and wherein determining the location of the autonomous scooter 100 within the environment is based at least in part on the map data, the position data and the orientation data; 312. Selecting a different light pattern from the plurality of light patterns based at least in part on a first location of the object before the visual alert is provided and a second location of the object after the visual alert is provided; 313. Causing the light emitter to provide a second visual alert, wherein the light emitter emits light indicative of the different light pattern into the environment; 314. Wherein the light emitter includes a sub-section and the light pattern includes a sub-pattern associated with the sub-section, the sub-section being configured to emit light indicative of the sub-pattern, wherein at least one of the sub-patterns is indicative of one or more of a signaling function of the autonomous scooter 100 or a braking function of the autonomous scooter 100 and wherein at least one other sub-pattern is indicative of the visual alert receiving data representing a sensor signal indicative of a rate of rotation of a wheel of the autonomous vehicle; and modulating the light pattern based at least in part on the rate of rotation.

The Planner system via GPS may process the object data and the local pose data to compute a path (e.g., a trajectory 345 of the autonomous scooter 100) for the autonomous scooter 100 through an operating environment. The computed path being determined in part by object data 334 in the environment 318 that may create an obstacle to one or more autonomous scooters 100 and/or may pose a collision threat to the autonomous scooter 100.

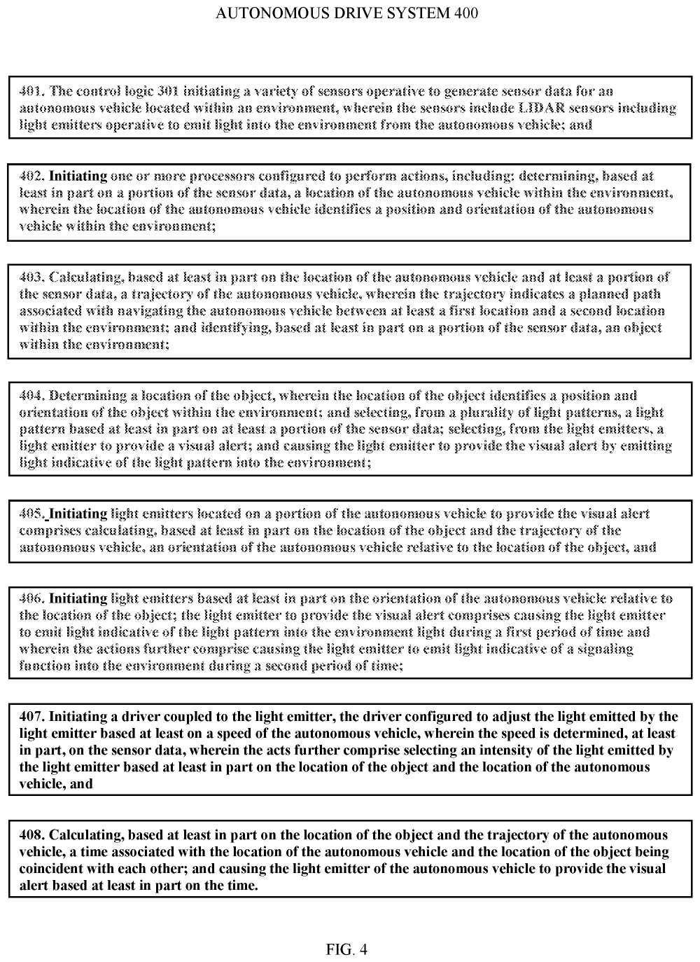

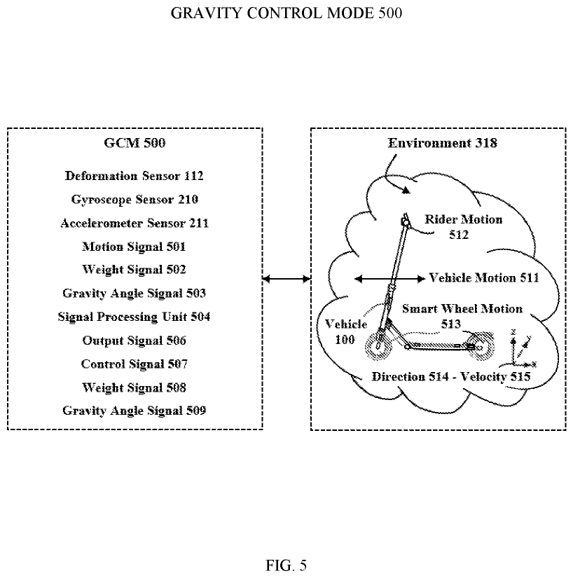

In greater detail FIG. 4 exemplifies a flowchart for an Autonomous Drive System 400 comprising platform system components 108-119 and methodologies 315-344 listed above, for providing semiautonomous control when activating by a user interface system 700 for controlling either type representative of the autonomous scooter 100 in an operating environment 318 (e.g., in real-time or in near-real-time) and generate (e.g., in real-time) sensor data 305 and 401. The control logic 301 initiating a variety of sensors operative to generate sensor data for an autonomous scooter 100 located within an environment, wherein the sensors include LIDAR sensors including light emitters operative to emit light into the environment from the autonomous scooter; and 402. Initiating one or more processors configured to perform actions, including: determining, based at least in part on a portion of the sensor data, a location of the autonomous scooter within the environment, wherein the location of the autonomous scooter 100 identifies a position and orientation of the autonomous scooter 100 within the environment; 403. Calculating, based at least in part on the location of the autonomous scooter 100 and at least a portion of the sensor data, a trajectory of the autonomous scooter, wherein the trajectory indicates a planned path associated with navigating the autonomous scooter 100 between at least a first location and a second location within the environment; and identifying, based at least in part on a portion of the sensor data and output signals, an object within the environment; 404. Determining a location of the object, wherein the location of the object identifies a position and orientation of the object within the environment; and selecting, from a plurality of light patterns, a light pattern based at least in part on at least a portion of the sensor data; selecting, from the light emitters, a light emitter to provide a visual alert; and causing the light emitter to provide the visual alert by emitting light indicative of the light pattern into the environment; 405. Initiating light emitters located on a portion of the autonomous scooter 100 to provide the visual alert comprises calculating, based at least in part on the location of the object and the trajectory of the autonomous scooter 100, an orientation of the autonomous scooter 100 relative to the location of the object, and 406. Initiating light emitters based at least in part on the orientation of the autonomous scooter 100 relative to the location of the object; the light emitter to provide the visual alert comprises causing the light emitter to emit light indicative of the light pattern into the environment light during a first period of time and wherein the actions further comprise causing the light emitter to emit light indicative of a signaling function into the environment during a second period of time; 407. Initiating a driver coupled to the light emitter, the driver configured to adjust the light emitted by the light emitter based at least on a speed of the autonomous scooter 100, wherein the speed is determined, at least in part, on the sensor data, wherein the acts further comprise selecting an intensity of the light emitted by the light emitter based at least in part on the location of the object and the location of the autonomous scooter 100, and 408. Calculating, based at least in part on the location of the object and the trajectory of the autonomous scooter 100, a time associated with the location of the autonomous scooter 100 and the location of the object being coincident with each other; and causing the light emitter of the autonomous scooter 100 to provide the visual alert based at least in part on the time.

In greater detail FIG. 5 illustrates a control diagram of an autonomous scooter 100 with a motion assistant gravity control mode 500 may include for example, and a deformation sensor 112, a gyroscope sensor 210 an accelerometer sensor 211, a motion signal 501, a weight signal 502, a gravity angle signal 503, a signal processing unit 504, an output signal 506, control signal 507, a weight signal 508 and a gravity angle signal 509 environment 318, the autonomous scooter's motion 511, a rider motion 512 and the wheel's motion 513, direction 515, and velocity 516.

In various environments 318 the gyroscope sensor 210 and the accelerometer sensor 211 may measure a motion signal 501 of a rider's motion 512 by pushing or shaking the footing portion or pad on the platform 102 and/or a 3-dimension moving response of the autonomous scooter 100 in the x, y, z direction 515 and velocity 516 associated with the rider's motion 512 and/or the example the autonomous scooter's motion 511. In one example, the motions 511/512 which may include a predefined motion input 501, including for example, the rider 101 hopping on and/or off the autonomous scooter 100.

In one example, a deformation sensor 112 may be computed by a weight signal 502 and a gravity angle signal 509 generated from one or more move control signals 507, including for example, forward, backward, accelerate, and/or brake signal 109a from a signal processing unit 504. The signal processing unit 504 may combine and process the deformation output signal 506 providing motion signals 501 to produce the one or more move control signals 507 relayed the autonomous drive system 600.

In some aspects control signals 507 may control the autonomous scooter 100 to move in a direction, including for example, a right or left forward direction or a backward direction. The direction of the autonomous scooter's motion 511 may be determined based on the deformation output signal 506 associated with the weight signal 508 and the gravity angle signal 509.

In some aspects control signals may control the speed of the autonomous scooter 100, for example, to accelerate or brake 109. In one example, the speed of the autonomous scooter's motion 511 may be determined based on a user's motion 512, such as shaking the autonomous scooter 100. In another example, the speed of the autonomous scooter's motion 511 may be determined based on the deformation output signal 506 associated with the weight signal 508 and the gravity angle signal 509. Respectively, the deformation sensor comprises a strain gauge 112a configured to sense induced strain by imbalanced forces exerted upon the wheel and the deformation sensor 112 to sense strain level 112b induced by a rider's weight exerted on the deformation sensor 112 to sense strain level induced by a rotation speed and twisting angle differences at a connection point generated at an intersection of the steering column 116, the wheel 108a and the platform's front end 103 and the deformation sensor 112 to sense strain level induced by a rotation speed and twisting angle differences at a connection point generated at an intersection of the wheel 108b and the platform's rear end 104.

For example, when a rider of an autonomous scooter 100 leans his or her body toward the wheel 108, for example, the front wheel's deformation sensor 112a may receive a higher pressure compared with the rear wheel's deformation sensor 112b. After signal correction and compensation from the gyroscope sensor 110 and the accelerometer sensor 111 in the motion input 501 according to the environment 318, movement and the rider's motion may be acquired and outputted to the PID control and driving control block, not shown.

The example of an autonomous scooter 100A which may be steered by the rider by shifting his or her weight to the right or left to complete a right turn or a left turn through the mechanical turn movement of the first and/or second wheels 108a, 108b, or the wheel's motion 513.

In greater detail FIG. 6 represents a flowchart for Autonomous Drive Mode 600, upon activation by the autonomous scooter rider, system methodologies comprising: Step 1. Establish an autonomous scooter's 100 initial orientation direction (IOD) 601 on the ground, and respective of the midpoint of the spinning center of mass (CM) 602 of the gyroscope sensor 210 and the accelerometer 211 and the activation of the wheel 108 to engage motor controller 212 to turn on battery 214 to power forward momentum 603 and acceleration speed 603a; Step 2. Detect rider's presence with pressure sensor 209 and footing placement activity working on the platform 102 establishing initial orientation direction (IOD) 601 and the rider 101 actively leaning forward engaging gyroscope sensor 210 and accelerometer 211 linking to the wheel 108 and brake unit 109; Step 3. Establish the control of the gyroscope sensor 210, turn on the wheel's motor controller 212 and turn on battery power system 213 relative to processors 212b; Step 4. Establish a deformation sensor 112 within a suspension fork 111 whereby the strain gauge 111a to sense induced strain by imbalanced forces exerted upon the autonomous scooter 100; Step 5. Establish deformation sensor 112 to sense strain level induced by a rider's weight exerted on the wheel 108 and during running maneuvers; Step 6. Establish strain levels induced by a rotation speed and twisting angle differences at a connection point generated at an intersection of the steering column 116, the wheel 108a and the platform's front end 103; Step 7. Establish a sense strain level induced by a rotation speed and twisting angle differences at a connection point generated at an intersection of the wheel 108b and the platform's rear end 104; Step 8. Establish the rider's posture leaning backward on the platform 102 thusly deactivating the gyroscope sensor 210 to turn off battery power system 213 directed to the motorized wheel 303 and brake 303(B) thus stopping forward momentum 603 to brake motion of the autonomous scooter 100.

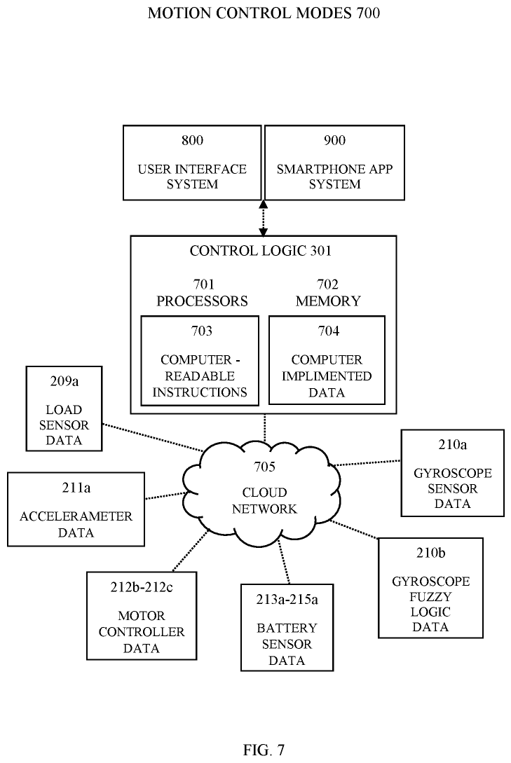

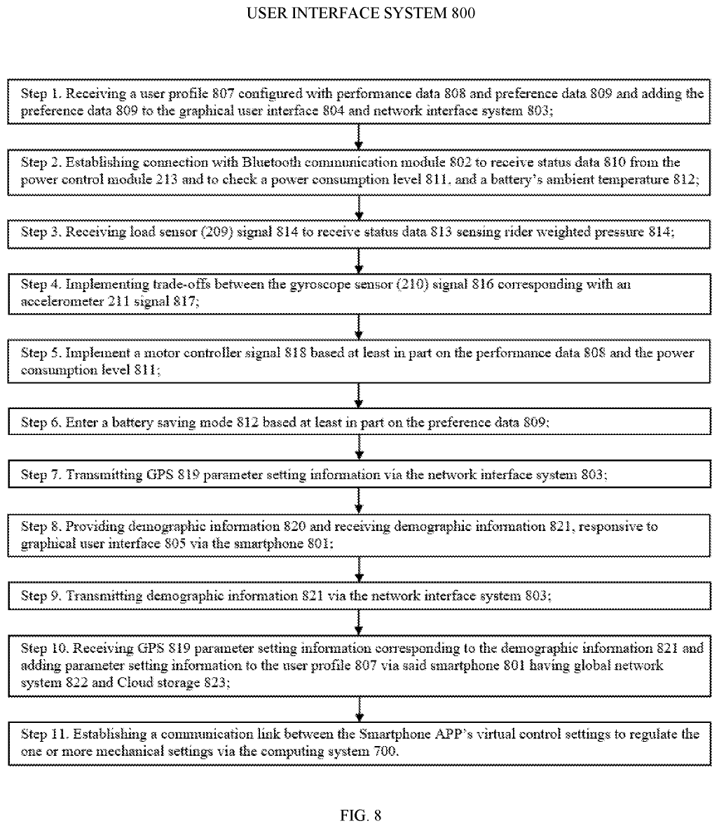

In greater detail FIG. 7 represents a flowchart for Manual Drive Mode 700, upon activation by the autonomous scooter rider, system methodology associated with control logic 210 including; a computing system comprising processor 701 processor 701 comprising memory 702 and software comprising computer-readable instructions 703 stored via Cloud network 704. Accordingly, an array of Bluetooth devices 222 which are linked the riders phone 801 to relay status, operating instruction and data information directly to control logic, wherein computer-implemented data 704 determining the operation status based on sensor device data including; load sensor data based on gyroscope sensor data 210a and base on accelerometer sensor data 211a. Establish the computer-implemented data 705 received from motor controller 212 server 212a and processor 212b, and motor controller sensor data 212c in sync with the motor sensor, not shown, battery power level 207, battery charger sensor data. Employ control logic 210 to receive processor 701 and memory 704 from sensor data 703 relative to said rider 101 including computer-readable instructions 703 gathered from gyroscope sensor data 210a and accelerometer data 211a and linking sensor data to computer-implemented data 704. Gather the computer-implemented data 804 directly analyze characteristic signatures of the gyroscope sensors fuzzy logic 210b and compares a signal from accelerometer 211 identifying changes in velocity, acceleration, orientation, rotation, translation, deformation, and changes to and combinations thereof. Establish GPS parameter setting information 819 via the network interface system 803 and providing demographic information 820 and receiving demographic information 821 via the User Interface System 800.

In greater detail FIG. 8 exemplifies a User Interface System 800 utilized to establish communication between the rider 101 and the autonomous scooter 100 via a phone 801 having a Bluetooth communication module 802 and WIFI 803 to receive computer readable-instructions 703 entered by rider 101 via the control logic. Wherein, the phone 801 is configured to transmit data to and from one or more Bluetooth devices 222 via a phone APP 900. The User Interface System 800 linking with a network interface system 804 via WIFI 803 to a phone APP 900. The User Interface System 800 linking the network interface system 804 to a graphical user interface 805. The User Interface System 800 linking with a network interface system 804 which is accessible from a phone's virtual display with keypad 806 for user input.

The User Interface System 800 further configured for linking with a network interface system 804 accordingly the phone's graphical user interface 805 is configured with multiple server prompt 806 scenarios including: Step 1. Receiving a user profile 807 configured with performance data 808 and preference data 809 and adding the preference data 809 to the graphical user interface 804 and network interface system 803; Step 2. Establishing connection with Bluetooth communication module 802 to receive status data 810 from the power control module 213 and to check a power consumption level 811, and a battery's ambient temperature 812; Step 3. Receiving a load sensor (209) signal 814 to receive status data 813 sensing the rider weighted pressure 814; Step 4. Implementing trade-offs between the gyroscope sensor (210) signal 816 corresponding with an accelerometer 211 signal 817; Step 5. Implement a motor controller signal 818 based at least in part on the performance data 808 and the power consumption level 811; Step 6. Enter a battery saving mode 812 based at least in part on the preference data 809; Step 7. Transmitting GPS 819 parameter setting information via the network interface system 803; Step 8. Providing demographic information 820 and receiving demographic information 821, responsive to graphical user interface 805 via the phone 801; Step 9. Transmitting demographic information 821 via the network interface system 803; Step 10. Receiving GPS 819 parameter setting information corresponding to the demographic information 821 and adding parameter setting information to the user profile 807 via said phone 801 having global network system 822 and Cloud storage 823; Step 11. Establishing a communication link between the phone APP's virtual controller settings 901 to control the one or more Bluetooth devices 222 mechanical settings via the computing system 700.

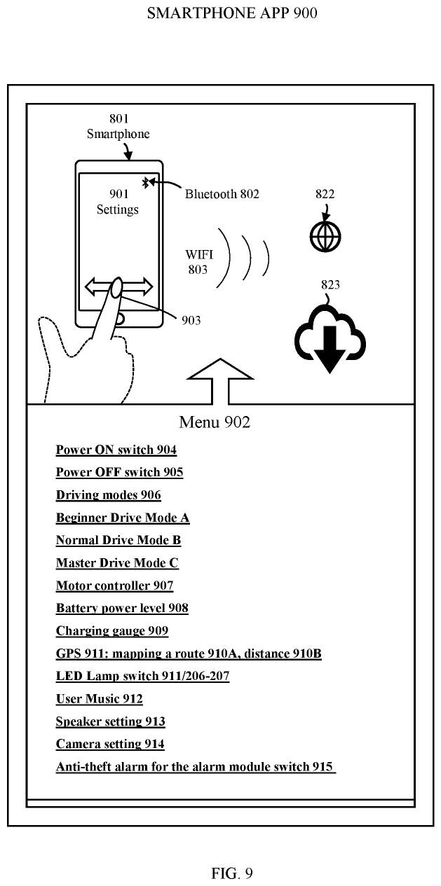

In greater detail FIG. 9 schematically illustrates a diagram representing a phone APP 900 accordingly, the rider 101 utilizes their phone 801 to access the virtual controller settings 901 which allows a rider 101 to control one or more Bluetooth devices with their phone APP 900. Accordingly, the phone APP 900 which can update future over-the-air software & firmware and manage social media and the internet of things via a Global network 901. The phone APP 900 allows the autonomous scooter rider 101 to select Bluetooth devices 222 listed on a menu 902 by the finger prompting 903 (i.e., swiping gestures).

Respectively the phone APP 900 controls of the following settings in relation to the virtually controlled Bluetooth devices 916 configured with virtual settings listed on the menu 902 as: a power on 903 and off switch 904, a Power switches 905; a Driving modes 906; Beginner Drive Mode A, Normal Drive Mode B, Master Drive Mode C; a Motor controller 907; a Battery power level 908; a Charging gauge 909; GPS 910: a mapping a route 910A, a distance 910B; LED Lamp switch 911/206-207; User Music 912; Speaker setting 913; Camera setting 914; and an Anti-theft alarm for the alarm module switch 915.

In this application, the terms stated above, the term “comprising of” unless otherwise indicated, and grammatical variations are “open” to include the added indefinitely listed element as well as to include the elements which they are listed thereof or “comprehensive” is intended to indicate the language.

Throughout the present disclosure, a particular embodiment of the example may be initiated in a range format. Range of type descriptions are merely for convenience and brevity and should not be construed as an inflexible limitation on the disclosed range.

The described embodiments of the invention are intended to be merely exemplary and numerous variations and modifications will be apparent to those skilled in the art. All such autonomous scooter 100 variations and modifications are intended to be within the scope of the present invention as defined in the appended claims.

I claim:

1-20. (canceled)

21. An autonomous scooter comprising:
framework including a deck, a base defined by a front end and a rear end configured with a wheel, and a control module housed within the base, wherein the front end further comprising a wheel adapter linking the wheel to a steering column such that, the steering column is mechanically rotatable to steer the autonomous scooter either manually or autonomously through motorized steering of the wheel adaptor when controlled by the control module;
a LED cording which provides lighting effects, LED headlamps situating on a front section of the steering column and the rear end configured turn signals and lamps;
wherein a platform situating on the deck to accommodate foot motion of a rider, or to accommodate a seat for the rider;
wherein the wheel at the front end may or may not include a motor;
wherein the wheel at the rear end includes a motor and brake connecting thereon, wherein the motor providing propulsion, via motor controllers linking to the control module in order to control speed of the autonomous scooter;
wherein the steering column further configured with handles, a throttle, a brake, and a control panel mounted in view of a rider of the autonomous scooter;
a battery and a battery charger contained within the base, wherein battery power linking, via the control module, to electrical components via wiring hidden from view;
a sensor system providing; a load sensor, an accelerometer sensor, a gyroscope sensor, a deformation sensor, an inertial measurement unit (IMU), configured for detecting motion, position or orientation of the rider during running operations; and
perception sensor affixed on the portions of frame and steering column, the perception sensors utilizing a LIDAR sensor and cameras for detecting objects surrounding the autonomous scooter, and configured for providing data to the control module such that, the autonomous scooter avoids threats during running operations;
wherein the control module associating with control modes involving one of; a manual drive mode or autonomous drive mode, and a gravity motion control mode, in which are selected by the rider;
wherein the rider physically controls the steering motion and speed of the autonomous scooter during manual drive mode;
wherein the wheel adapter configured for turning the steering column and the wheel at various steering directions based on the control module activating a steering process during autonomous drive mode operation in order to control steering of the autonomous scooter;
wherein the throttle and the brake are systematically engaged during autonomous mode setting through the control module process;
wherein the control panel configured providing one of; a menu, gauges an operation start key to operate the autonomous scooter; wireless communication through WIFI, Bluetooth, and a smartphone providing user interface;
a user interface involving a plan, in which the rider physically controls the motion and position of the autonomous scooter during running operations involving manual drive or autonomous drive; or
a user interface involving a plan, in which the rider wirelessly controls the motion and position of the autonomous scooter during running operations through use of a smartphone APP programming achieved by Wi-Fi or Bluetooth process;
GPS for establishing local mapping in which the autonomous scooter navigates, and generate route data, accordingly GPS being attainable through the control panel or through the smartphone;
wherein the control panel providing a touch screen with touch gesture input for user interface input processes involving one of; a fingerprint reader, iris reader, a facial recognition system, a speech recognition device, or any other biometric device;
wherein the control panel configured for displaying performance operation of the autonomous scooter, or monitoring a remaining battery level, a moving speed, an odometer or trip meter and summary of important information useful for rider;
a user interface associating the rider wirelessly accesses a smartphone APP through their smartphone via a Wi-Fi or Bluetooth, the smartphone APP providing a process in which the rider monitors position of the autonomous scooter, or monitors a moving speed, an odometer or trip meter, a remaining battery level and summary of important information useful for the rider.

22. The autonomous scooter of claim 21 in which the base defined by a front end further comprising one of:
a steering column being adjustable and configured with handles, a throttle and a brake each being activated by a lever disposed thereon;
a framework configured with an adjustable steering column;
the adjustable steering column configured with one or more collapsible handles to steer the autonomous scooter during a manual mode setting;
the adjustable steering column configured with a throttle and brake which are activated by the rider during the manual mode setting.

23. The autonomous scooter of claim 21 in which the gravity motion control mode for detecting a rider-induced motion or position whilst a rider is onboard which involves one of:
as the rider leans forward motor speed is increased;
as the rider leans back the motor speed is decreased;
as the rider leans right or left, the rider assist balance and steering control of the autonomous scooter.

24. The autonomous scooter of claim 21 in which one or more motor controllers linking to one of;
A wheel adapter, during autonomous drive mode operation, automatically turns a steering column and a wheel in various steering directions.

25. The autonomous scooter of claim 21 in which the first and second smart wheels further comprising motor controllers and sensors configured to cause the motors of the first and second smart wheels to propel the scooter and to turn the autonomous scooter correspondingly.

26. The autonomous scooter of claim 21 in which the autonomous drive system further comprising:
motor controllers further configured to cause the first smart wheel's right motor and left motor to autonomously steer said autonomous scooter and the second smart wheels right motor and left motor to autonomously steer said autonomous scooter.

27. The autonomous scooter of claim 21 in which the base defined by a rear end further comprising one of: a motor and brake connecting thereon;
wherein the motor providing propulsion, via motor controllers linking to the control module in order to control speed of the autonomous scooter.

28. The autonomous scooter of claim 21 in which the system system's sensors provide output signals with data to the autonomous drive system, the sensor system comprising one or more of:
a load sensor configured to sense an orientation of an autonomous scooter rider;
a deformation sensor configured to generate a weight signal;
a gyroscope providing a gravity angle signal;
perception sensors being a LIDAR sensor and cameras detection objects surrounding the autonomous scooter, the LIDAR sensor providing data through signals.

29. An autonomous scooter comprising:
framework including a deck, a base defined by a front end configured with a wheel and rear end configured with a motor and brake arrangement connecting thereon, wherein the front end comprising a steering column configured with handles, a throttle, a brake, a control module linking to a control panel mounted in view of a rider, and batteries housed within the base linking to electrical components via wiring;
a LED cording which provides lighting effects, LED headlamps situating on a front section of the steering column and the rear end configured turn signals and lamps;
wherein the steering column being manually steered by the rider who is standing or sitting;
wherein the rider using a throttle, a brake to control speed of the wheel's motor;
the control module associating with an autonomous drive mode linking to a LIDAR sensor and cameras configured for detecting objects surrounding the autonomous scooter, and configured for providing sensor data and camera data to the rider through a display of the control panel;
wherein the rider physically controls the steering motion and speed of the autonomous scooter during manual drive mode;
wherein the control panel configured providing one of; a menu, gauges an operation start key to operate the autonomous scooter; wireless communication through WIFI, Bluetooth, and a smartphone providing user interface;
GPS for establishing local mapping in which the autonomous scooter navigates, and generate route data, accordingly GPS being attainable through the control panel or through the smartphone;
wherein the control panel configured for displaying performance operation of the autonomous scooter, or monitoring a remaining battery level, a moving speed, an odometer or trip meter and summary of important information useful for rider;
a user interface associating the rider wirelessly accesses a smartphone APP through their smartphone via a Wi-Fi or Bluetooth, the smartphone APP providing a process in which the rider monitors position of the autonomous scooter, or monitors a moving speed, an odometer or trip meter, a remaining battery level and summary of important information useful for the rider.

30. The autonomous scooter of claim 29 in which the base further comprising one of:
a steering column configured with handles, a throttle, a brake, and a control panel mounted in view of a rider of the autonomous scooter;
wherein the steering column is mechanically rotatable to steer the autonomous scooter either manually or autonomously through motorized steering of the wheel adaptor when controlled by a control module process.

31. The autonomous scooter of claim 21 in which the gravity motion control mode for detecting a rider-induced motion or position whilst a rider is onboard which involves one of:
as the rider leans forward motor speed is increased;
as the rider leans back the motor speed is decreased;
as the rider leans right or left, the rider assist balance and steering control of the autonomous scooter.

32. The autonomous scooter of claim 21 in which the autonomous drive system configured to autonomously control speed and steering of the autonomous scooter with a rider present.

33. The autonomous scooter of claim 21 in which the autonomous drive system further comprising:
algorithms configured for adjusting the moving speed of a motor, or a turn direction of the one or more wheels;
wherein an IMU provides a value of a turn angle value of a motor of a wheel adapter;
algorithms configured to calculate an actuator angle value based on the turn angle value and a predetermined target roll angle; and actuate the motor or the motorized wheel adapter to the angle value.

34. The autonomous scooter of claim 29 in which the autonomous drive system correlating with a user interface allowing a rider to select control modes including a manual drive mode for manually controlling the autonomous scooter when a user is present.

35. The autonomous scooter of claim 21 in which the autonomous drive system associated with remotely via a Cloud Interface Network activating at least one of:
a user interface involving a plan, in which the rider physically controls the motion and position of the autonomous scooter during running operations involving manual drive or autonomous drive;
a user interface involving a plan, in which the rider wirelessly controls the motion and position of the autonomous scooter during running operations through use of a smartphone APP programming achieved by Wi-Fi or Bluetooth process;
a user interface associating the rider wirelessly accesses a smartphone APP through their smartphone via a Wi-Fi or Bluetooth, the smartphone APP providing a process in which the rider monitors position of the autonomous scooter, or monitors a moving speed, an odometer or trip meter, a remaining battery level and summary of important information useful for the rider.

36. The autonomous scooter of claim 21 in which an inertia measurement unit or IMU sensing a movement of wheel to stabilize the autonomous scooter.

37. The autonomous scooter of claim 29 in which the smartphone's APP further configured with software which allows one or more of;
a rider to interact with the autonomous scooter during operation; or allows rider to interact with an autonomous driving function based on the rider's request to navigate the autonomous scooter directly to the rider's location, based on one or more GPS mapping plans via rider instructions.

38. The autonomous scooter of claim 29 in which at least one processor to:
receive information from GPS in relation to determine the whereabouts of the user of the autonomous scooter;
receive information from GPS to determine a location of the user and navigate to a destination coordinating to the location of a user;
receive information from GPS to determine a location of the autonomous scooter to safely progress on a planned current route to a destination.

39. The autonomous scooter according to claim 29 in which user interface involving one of:
a touch screen configured with virtual driving control settings and a virtual controller for navigating the autonomous scooter via WIFI or Bluetooth link;
a smartphone associating with one of: WIFI and Bluetooth configured to wirelessly link a rider to the autonomous drive system of the autonomous scooter;
the smartphone's APP configured with programming for linking to the autonomous drive system and configured to receive sensor data to remotely navigate the autonomous scooter.

40. The autonomous scooter of claim 21 in which the user interface further comprising:
a non-transitory computer readable medium having computer readable instructions stored thereon, that when executed by at least one processor to achieve one of;
receive information from the one or more sensors is in relation to the autonomous scooter;
receive information from GPS to determine a current location of a rider;
to remotely navigate the autonomous scooter to a destination coordinating to the location of a user summoning the autonomous scooter, via a smartphone APP.
